(19) United States
(12) Patent Application Publication
(10) Pub. No.: US 2006/0153256 A1
(43) Pub. Date: Jul. 13, 2006

(54) Laser temperature performance compensation

(76) Inventor: Jorge Sanchez, Poway, CA (US)

Correspondence Address: HIGGS, FLETCHER & MACK LLP, 2600 FIRST NATIONAL BANK BUILDING, 401 WEST "A" STREET, SAN DIEGO, CA, 92101-7910, US

(21) Appl. No.: 10/513,105

(22) PCT Filed: Jan. 14, 2003
(86) PCT No.: PCT/US03/01032

§ 371 Date: Oct. 29, 2004

Related U.S. Application Data
(63) Continuation-in-part of application No. 09/724,692, filed on Nov. 28, 2000, now Pat. No. 6,629,638.
Application No. 09/724,692 is a continuation-in-part of application No. 09/472,709, filed on Dec. 24, 1999, now Pat. No. 6,446,867.

(51) Int. Cl. H01S 3/04

(52) U.S. Cl. 372/34

(57) ABSTRACT

The invention presents a method that calibrates the laser optical power in a continuous manner without disrupting the flow of information in the optical communications link. The method utilizes knowledge of the measured value of the laser optical power and makes necessary adjustments to optimize the values of the Extinction Ratio, Bit Error Rate and to compensate for aging. The method utilizes knowledge of the temperature from a sensor and mathematical models, which contain parameters which are updated for a specific laser configuration.

### CROSS REFERENCES TO RELATED APPLICATIONS

This application is a continuation in part application for copending U.S. patent application Ser. No. 09/724,692 filed on Nov. 28, 2000, entitled “Electro-Optic System and Controller and Method of Operation,” which in turn is a continuation in part of application Ser. No. 09/472,709 filed on Dec. 24, 1999, entitled “Electro-Optic Interface System and Method of Operation,” now U.S. Pat. No. 6,446,867 B1. This application is a conversion of provisional application Ser. No. 60/348,967, filed Jan. 14, 2002, entitled “Laser Power Sensing Methods.”

### REFERENCE TO OTHER APPLICATIONS

This application is a continuation in part application for co-pending U.S. patent application Ser. No. 09/724,692 filed on Nov. 28, 2000, titled “Electro-Optic System Controller and Method of Operation”. This utility application is also filed based on provisional application 60/348,967 filed Jan. 14, 2002, entitled “Laser Power Sensing Methods.”

### BACKGROUND

1. Field of the Invention

The invention relates to a set of methods used to compensate the performance of lasers given changes with temperature. Precise sensing of laser power magnitudes is obtained with the use of temperature sensors and slow photodiodes and without any disruption of data transmission.

2. Description of the Related Art

A substantial number of lasers are monitored with the use of photodiodes that are integrated with the laser in the same package or that are part of an integrated circuit that is associated with the driver or a VCSEL laser array. In addition, temperature sensors are utilized to determine when adjustments are appropriate. There is a significant demand in the industry to understand and control the magnitude of the optical power in order to perform adjustments to the laser driver to stabilize the extinction ratio and reduce the Bit Error Rate (BER).

Unresolved Problems Related to Sensing Laser Power.

It is common to utilize very slow photodiodes for monitoring the laser output. In some cases the photodiodes exhibit a frequency response that is several orders of magnitude lower than the frequency response of the laser. This type of performance poses a problem in determining the amplitude of the optical pulses for transmitting information since in some cases the photodiode will not generate significant output in response to the ac power output representing the data transmission. In digital communications, the amplitude of the optical pulses is necessary in order to distinguish the transmission of a logical one from the transmission of a logical zero.

In both analog and digital communications, the magnitude of the optical signal represents the strength of the signal and has a direct impact on signal to noise ratio and transmission reliability.

Sensing the power with slow photodiodes poses a problem because only the average power of the laser is sensed due to the low frequency response of the photodiode. This situation prevents the laser control system from determining the amplitude of the data transmission light pulses. Thus, adequate feedback information will not be available to adjust the magnitude of optical pulses representing the data. The optical output will not be properly controlled and the Extinction Ratio and Bit Error Rate (BER) will change with temperature and well as with aging.

### SUMMARY OF THE INVENTION

The method in this invention calibrates and stabilizes the bias and modulation currents. The threshold needed to turn on the laser is determined and a minimum DC bias current is chosen above the threshold. A value for the temperature drift model of the threshold current is determined and the value is stored in the Digital Controller (111) memory. Temperature coefficients for other parameters are stored in the Digital Controller (111). Once the system is in the field, the control system utilizes the photodiode sensor to continuously adjust the value of the average laser current to a fixed value above the minimum laser threshold. With the use of various algorithms, the value of the optical power corresponding to the logic one is adjusted to maximize signal transmission reliability.

### BRIEF DESCRIPTION OF THE DRAWINGS

Details of the invention, and of the preferred embodiment thereof, will be further understood upon reference to the drawings:

FIG. 1 illustrates a control system diagram for a laser transmitter;

FIG. 2 illustrates the timing diagram for the calibration process; and

FIG. 3 illustrates graphically the calibration method.

### DETAILED DESCRIPTION OF AN EMBODIMENT

The above-mentioned unresolved problems related to laser sensing power are overcome by the present invention.

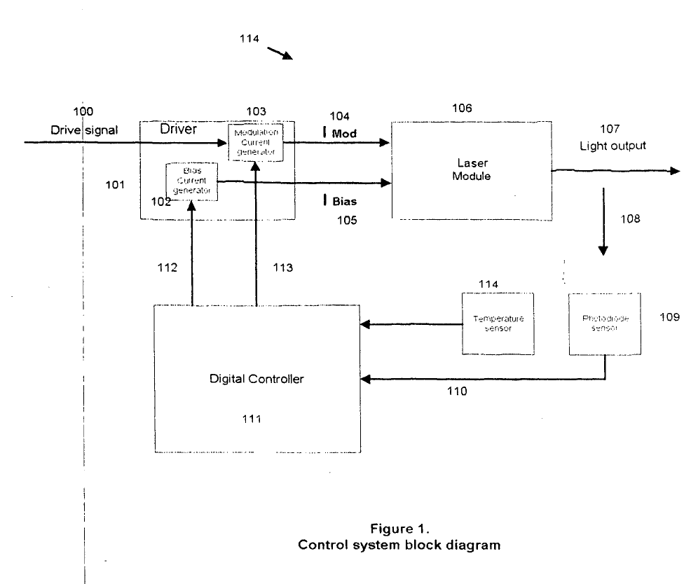

FIG. 1 shows a block diagram for a Laser Control System (114). The system consists of a drive Signal Input (100) applied to a Laser Module Driver (101), which contains a Bias Current Generator (102) and a Modulation Current Generator (103). The current generators are controlled by Bias Control Signal (112) and Modulation Control Signal (113). The Driver (101) produces Modulation Current (104) and Bias Current (105), which are applied to the Laser Module (106). The Laser Module (106) in turn produces Light Output (107). The magnitude of the Light Output (107) bears a relationship to the magnitude of the Modulation Current (104) and the Bias Current (105). A portion of the Light Output (107) from the laser is sensed. This constitutes the Optical Power Sense (108), which is coupled to a Photodiode Sensor (109). The Photodiode Sensor Output (110) is connected to a Digital Controller (111). In addition, a temperature sensor (114) provides temperature information to the Digital Controller (111). The Digital Controller (111) contains algorithms for laser control and also determines the magnitudes of the Bias Current Generator (102) and Modulation Current (103).

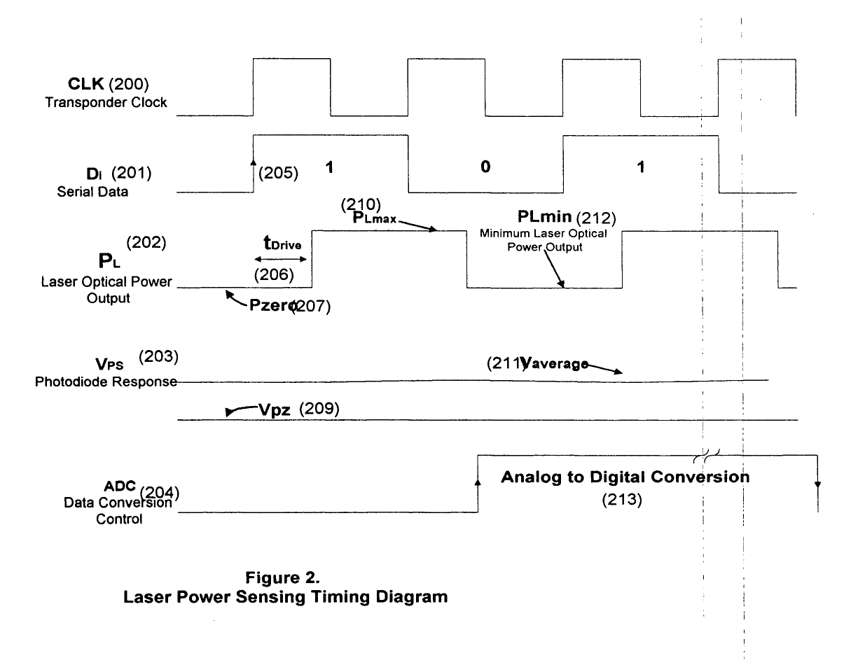

FIG. 2 shows the timing of the calibration of the laser optical power. As a reference to the timing of the system, a system clock CLK (200) is utilized by a transponder. The transponder is an optical communications transceiver with interface to a parallel computer bus. The clock (200) is utilized in the system to generate Serial Data Di (201). In this example the Serial Data Di (201) consists of a sequence 101. The data transmission of the timing diagram in the illustration corresponds to NRZ-L. After the zero to one transition of the Serial Data Di at (205), the data flows through the Driver (103) and causes a zero to one transition in Laser Optical Power Output P_{L} (202). This transition of the Laser Optical Power (202) happens after a delay t_{Drive} (206), corresponding to the delay of the signal flowing through the Driver (103) and the Laser (106). A given setting of the Bias Current Generator (102) places the Laser (106) at a value above the threshold. This setting can be adjusted and controlled independently from the signal modulation current. For the purpose of calibrating the Light Output (107), the control of the Laser Bias Current Generator (102) is used. Corresponding to the pulse of the Serial Data Di (201), there is an amplitude of the Laser Optical Power Output P_{L} (202). The magnitude of the Optical Power Output (202) is noted as PLmax (210). The laser optical power corresponding to the transmission of a logical 1 will vary depending on the setting of the Modulation Current Generator (103), the Laser (106) characteristics and the effects of factors such as temperature and aging on the Laser (106). The magnitude of the laser power output corresponding to a transmission of a logical zero is PLmin (212). This power output corresponds to the power generated from the application of the bias current from the Bias Current Generator (102). Light from the laser is sensed by the Photodiode (109). There may be a sample and hold device inserted between the photodiode sensor and the analog to digital converter that is part of the controller (111). There is generally an amplifier connected to the photodiode output that is used to amplify the photodiode signal. The photodiode amplifier will generate a voltage output corresponding to the optical power sensed by the photodiode (109). Since the Photodiode (109) is relative slow, the sensing circuit will exhibit a Photodiode response, which corresponds to an average photodiode response VPS (203) of the laser power received by the photodiode. The steady value of the photodiode response integrates the value of the laser optical power output (202). In the example illustrated in FIG. 2, the Serial Data (210) is assumed to be so fast, that the photodiode senses only the average of a laser optical power pulse. The zero photodiode current VPZ (209) is the Photodiode response with no applied laser power and may correspond to a photodiode dark current. This current can be subtracted from all measurements to further preserve accuracy with temperature changes. As is discussed below, one need to rely only on the average current to control and stabilize the laser output.

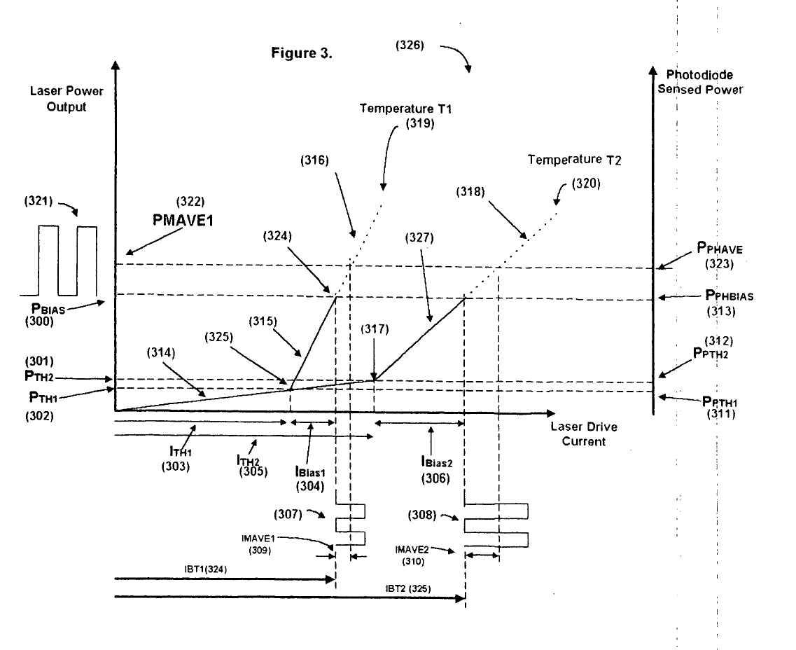

In FIG. 3, the Laser Power Sensing Method is illustrated.

The characteristic 319 corresponds to the overall laser response at temperature T1.

The characteristic is comprised of several piecewise linear sections. The first section 314 is the region before the laser threshold is reached; the second region. The second region 315 corresponds to the combined transfer characteristic of the bias current source and the laser beyond threshold. The third region 316 corresponds to the combined transfer characteristic of the modulation current source and the laser beyond threshold. Since the bias and modulation current are summed together, using the superposition principle, we can graphically represent the overall transfer characteristic by stacking 316 on top of 315. The origin of 316 is at the bias set point (324). This characteristic exhibits a threshold current of ITH1 (303). Corresponding to this particular threshold, there is a laser power output PTH1 (302) and a sensed photodiode power PPTH1 (311) by the photodiode detector. In this example a laser bias current IBIAS1 (304) with a value above the threshold is shown. The bias current produces a corresponding optical power output from the laser PBIAS (300). A portion of the laser optical power output is sensed by the photodiode resulting in a photodiode output PPBIAS (313). Data transmission is accomplished by applying a modulation current to the laser represented by a square wave (307). The power output is represented by the square wave (321). The above parameter values are determined during the factory calibration of the laser and photodiode.

Calibration Process Adjustments at a First Temperature T1.

The following calibration process for Bias and Gain are is carried out in the laser transmitter factory. The temperature at the factory is referred to as T1.
1. Threshold current ITH1 (303) is obtained at power up with an algorithm that uses the photodiode to find the threshold by monitoring the slope of the laser characteristic. The modulation current (307) is turned off while the system searches for the threshold. When the slope changes, the threshold is found. Obtaining the threshold may require averaging of the monitored signal to account for noise in the system. A signal-processing algorithm with a digital filter may also be used.
2. Additional Bias current IBIAS1 (304) is applied as required by the specific design of the system. We thus set the Bias Current Generator (102) to produce a Total Bias Current I=IBT1 (324)=ITH1 (303)+IBIAS1 (304). During the factory calibration, the photodiode sensor (109) and the temperature sensor (114) sense the power and temperature. Values are recorded in order to calibrate the measurement. At the same time, actual laser power is determined with an external Optical Power Meter connected to the output of the laser.
3. Laser power PTH1 is obtained from the value given by the Optical Power Meter. The value of the photodiode current PPTH1 (311) is measured and an Optical Power Meter determines the light output (107) from the laser.
4. Above data provides two sets of data points 324, 325, which are used to obtain the slope GB1 of the laser characteristic in section 315 at temperature T1.
5. A scaling factor K for the photodiode sensor is determined using the two sets of photodiode values obtained PPTH1 (311) and PPTH2 (312) corresponding to the actual values ready by the Optical Power Meter PTH1 (302) and PTH2 (301). Photodiode transfer characteristic is assumed to be linear.
6. Set the total bias current to IBT1 (324)
7. Apply a modulation current (307). This current is generated by a second current source and is added to the bias current. The modulation current is of a necessary average value IMAVE1 (309). This modulation current can be obtained either by using a steady DC modulation current value IMAVE1 (309) or by a suitable train of square waves (307). IMAVE1 (309) is modified until the required value of PMAVE1 (322), which is needed for the transceiver is obtained. As before, an Optical Power Meter is used to determine a calibrated value of the power.
8. The corresponding value of the photodiode sensor (109) reading is recorded for calibration purposes
9. Compute the slope GM1 of the laser characteristic in section 316 at temperature T1
10. Parameters for model of temperature drift of the threshold current for the laser are entered in the Digital Controller (111).
11. The temperature coefficients TCOGB and TCOGM corresponding to the slope for the Bias (GB) and Modulation (GM) slope are stored in the Digital Controller (111).
   Calibration Adjustments at a Second Temperature T2.

All adjustments after the factory calibration and after the power up sequence of the laser transmitter are used to account for temperature changes and are made on a continuous basis and without interrupting the transmission of information. Because the adjustments are made on a continuous basis, the extinction ratio is preserved and BER is minimized.

Temperature of the laser is constantly monitored and at the appropriate temperature change a calibration control process is executed. For the purpose of maintaining calibration at temperature T2, the threshold ITH2 (305) is determined with a mathematical model of the threshold current change with temperature (drift). This model can be a table of values of the threshold current for temperature data points, a coefficient for the drift or an equation. For example, in VCSEL (Vertical Cavity Surface Emitting Laser) lasers this drift can be modeled with an equation where the threshold current versus temperature characteristic exhibits a quadratic relationship about an initial value.

The portion of the characteristic before the threshold (314) can be approximated with a straight line using a piecewise linearity method. With this method, a line extends from the origin to the data point 325 with coordinate values of ITH1 (304) and PTH1 (302). The threshold drift model yields the value of PPTH2 (312) and the laser power output PTH2 (301). We can assume that the photodiode transfer characteristic drift will have a negligible error due to temperature changes although a model can be incorporated into the system to account for temperature drift.

The following list shows the process for performing adjustments to compensate for the temperature change to an arbitrary value of T2.

Calibration at temperature T2. In this process, it is assumed that the transceiver is installed and is sending data at a steady rate.
1. An updated value of the threshold current ITH2 (305) at the new temperature T2 is obtained from the temperature drift model of the laser threshold current.
2. An updated value of the Bias current IBIAS2 (306) at the new temperature T2 is obtained using the temperature coefficient for the laser bias current.
3. The total bias current IBT2 (324)=ITH2 (305)+IBIAS2 (306) at the new temperature T2 is determined and then applied by adjusting the bias current generator (102) with the new value.
4. The Modulation current IMAVE2 (310) at the new temperature is determined using the temperature coefficient of the modulation (TCOGM). This value of IMAVE2 (310) is such that the light output (107) is preserved to a value of PMAVE1 (322). The Modulations current generator (103) is adjusted to produce the new value of IMAVE2 (310).

The previous embodiment uses temperature for feedback to the control system. Alternative embodiments also use the average power sensed by the photodiode PPHMAVE (323) to adjust the modulation current.

In this case, a measurement is done by averaging the signal from the photodiode (109) over numerous cycles of the input Drive Signal (100). In digital data transmission, Commonly, data patterns are not allowed to become all 1's or all 0's. Thus long averaging of the light output (107) will result on a value of the power corresponding to approximately ½ the amplitude of the peak value of the power. Average power information is then used to set modulation current IMAVE2 (310) to the correct amount that yields the original value of the power PMAVE1 (322) at the prior temperature T1.

Extinction Ratio and Bit Error Rate Optimization.

Once the laser characteristic is calibrated at the new temperature T2 optimal value of extinction Ratio and minimal Bit Error Rate are obtained. The firmware imbedded in the Digital Controller (111) utilizes the results from the A/D conversion of the sensor and proceeds to make adjustments to the amplitude of the peak laser power in response to the logic high sent. The laser power for logic high needs to send a signal with a sufficiently large value according to the transmission protocol. With the precision power measurement circuit of this invention, the laser is not overdriven thus extending operating life.

The Digital controller (111) makes adjustments to the minimal optical power in response to the logic low sent and. The minimal optical power is determined by the Bias Current Generator (102) and is adjusted above the threshold of the laser. The current needs to strike a balance between having too low of a value (needed to maximize extinction ratio) or too high of a value (needed to obtain a margin over the lasing threshold and to not operate over the noisy region of the laser near the threshold). Since one can conduct the above adjustments on a continuous manner, the laser is always operated at the optimal levels of power output.

Other embodiments of the algorithms described above can be applied as well to analog signal transmission or other laser applications.

While the foregoing description has described the principle and operation of the present invention in accordance with the provisions of the patent statutes, it should be understood that the invention may be practiced otherwise as illustrated and described above and that various changes in the size, shape, and materials, as well as on the details of the illustrated method of operation may be made, within the scope of the appended claims without departing from the spirit and scope of the invention.

What is claimed is:

1. (canceled)

2. (canceled)

3. (canceled)

4. (canceled)

5. (canceled)

6. A method for initial calibration of laser output power comprising:
finding an initial threshold bias current value by applying an increasing bias current signal to a laser, and sensing a laser output monitoring signal with a photodiode sensor while applying a mathematical threshold determination algorithm to the signal to determine when a first slope of the laser output monitoring signal changes;
storing the initial threshold bias current value in non-volatile memory;
determining at least two output monitoring data points created by continuing to sense the laser output monitoring signal with the photodiode sensor;
applying a mathematical photodiode responsiveness algorithm to the two output monitoring data points to determine the slope of the laser output monitoring signal;
determining at least two power output bias data points created by applying a bias current to the laser and sensing a laser output bias power signal with an optical power meter;
applying a mathematical bias slope determination algorithm to the two power output bias data points to determine a slope of the laser output bias power signal;
determining at least two power output modulation data points created by applying a modulation current to the laser and sensing a laser output modulation power signal with the optical power meter;
applying a mathematical modulation slope determination algorithm to the two power output modulation data points to determine a slope of the laser output modulation power signal;
determining a temperature coefficient of the laser output bias power signal slope;
determining a temperature coefficient of the laser output modulation power signal slope;
storing the bias power signal slope temperature coefficient in non-volatile memory; and,
storing the modulation power signal slope temperature coefficient in non-volatile memory.

7. The method of claim 6 wherein the calibration is performed in a factory setting at an initial temperature T1.

8. The method of claim 6 further comprising averaging the laser output monitoring signal to account for noise.

9. The method of claim 6 wherein a mathematical algorithm comprises a signal processing algorithm using a digital filter.

10. The method of claim 6 further comprising applying an operating bias current to the laser and storing an operating bias current value in non-volatile memory.

11. The method of claim 6 further comprising applying an operating modulation current to the laser and storing an operating modulation current value in non-Volatile memory.

12. A method for compensating laser characteristic changes with temperature comprising:
determining a temperature change from an original temperature to a new temperature;
determining a new initial threshold bias current computed from the temperature change and a stored initial threshold bias current;
determining a new operating bias current computed from the temperature change, a stored bias power signal slope temperature coefficient and a stored operating bias current value;
applying the new operating bias current to a laser;
determining a new operating modulation current computed from the temperature change, a stored modulation power signal slope temperature coefficient and a stored operating modulation current value; and,
applying the new operating modulation current to the laser.

13. A method for compensating laser characteristic changes with temperature comprising:
determining a temperature change from an original temperature to a new temperature;
determining a new initial threshold bias current computed from the temperature change and a stored initial threshold bias current;
determining a new operating bias current computed from an average power value sensed by a photodiode sensor and a stored operating bias current value;
applying the new operating bias current to a laser;
determining a new operating modulation current computed from the temperature change, a stored modulation power signal slope temperature coefficient and a stored operating modulation current value; and,
applying the new operating modulation current to the laser.
